(19) United States
(12) Patent Application Publication
(10) Pub. No.: US 2016/0166090 A1
(43) Pub. Date: Jun. 16, 2016

(54) FLORAL ARRANGEMENT HOLDER AND WRITING SURFACE COMBINATION ASSEMBLY

(71) Applicant: Splash Brands GmbH, Duesseldorf (DE)

(72) Inventor: Ralf Tuennermann, Duesseldorf (DE)

(21) Appl. No.: 14/568,451

(22) Filed: Dec. 12, 2014

(51) Int. Cl. A47G 7/06; B65D 85/50; B43K 29/20; B65D 25/20

(52) U.S. Cl. CPC A47G 7/06; B65D 25/20; B65D 85/505; B43K 29/20

(57) ABSTRACT

A floral arrangement holder and writing surface combination assembly includes a housing that has a bottom wall and a perimeter wall that is attached to and extends upwardly from the bottom wall. The perimeter wall has an upper edge defining an opening into an interior of the housing. The perimeter wall includes a front wall having a depression therein. The depression is defined by a rear wall and a peripheral wall is attached to and extends between the rear wall and the perimeter wall. A panel is removably positioned over the depression and a coupler releasably mounts the panel over the depression. A marking utensil for marking on the panel is removably positioned within the depression.

### BACKGROUND OF THE DISCLOSURE

### Field of the Disclosure

The disclosure relates to container and writing surface combination devices and more particularly pertains to a new container and writing surface combination device for providing means both for the displaying of flowers and the like as well as a removable surface upon which multiple persons may write.

### SUMMARY OF THE DISCLOSURE

An embodiment of the disclosure meets the needs presented above by generally comprising a housing that has a bottom wall and a perimeter wall which is attached to and extends upwardly from the bottom wall. The perimeter wall has an upper edge defining an opening into an interior of the housing. The perimeter wall includes a front wall having a depression therein. The depression is defined by a rear wall and a peripheral wall that is attached to and extends between the rear wall and the perimeter wall. A panel is removably positioned in the depression. The panel has an outer surface comprising a dry erase board. A coupler releasably mounts the panel in the depression and a marking utensil comprising a dry erase marker is removably positioned within the depression.

An embodiment of the disclosure further meets the needs presented above by generally including a housing that has a bottom wall and a perimeter wall that is attached to and extends upwardly from the bottom wall. The perimeter wall has an upper edge defining an opening into an interior of the housing. The perimeter wall includes a front wall having a depression therein. The depression is defined by a rear wall and a peripheral wall is attached to and extends between the rear wall and the perimeter wall. A panel is removably positioned over the depression and a coupler releasably mounts the panel over the depression. A marking utensil for marking on the panel is removably positioned within the depression.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a floral arrangement holder and writing surface combination assembly according to an embodiment of the disclosure.

FIG. 2 is a top view of an embodiment of the disclosure.

FIG. 3 is a front view of an embodiment of the disclosure.

FIG. 4 is a cross-sectional view of an embodiment of the disclosure taken along line 4-4 of FIG. 3.

FIG. 5 is an exploded perspective view of an embodiment of the disclosure.

FIG. 6 is a front in-use view of an embodiment of the disclosure.

### DESCRIPTION OF THE PREFERRED EMBODIMENT

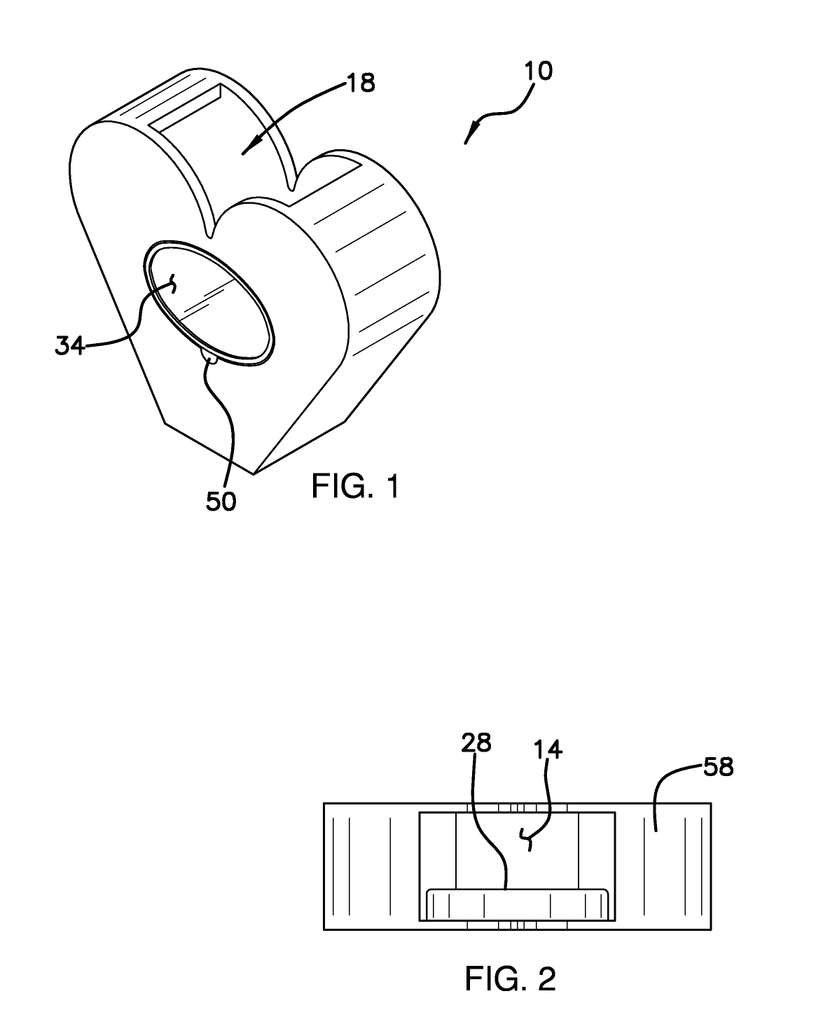

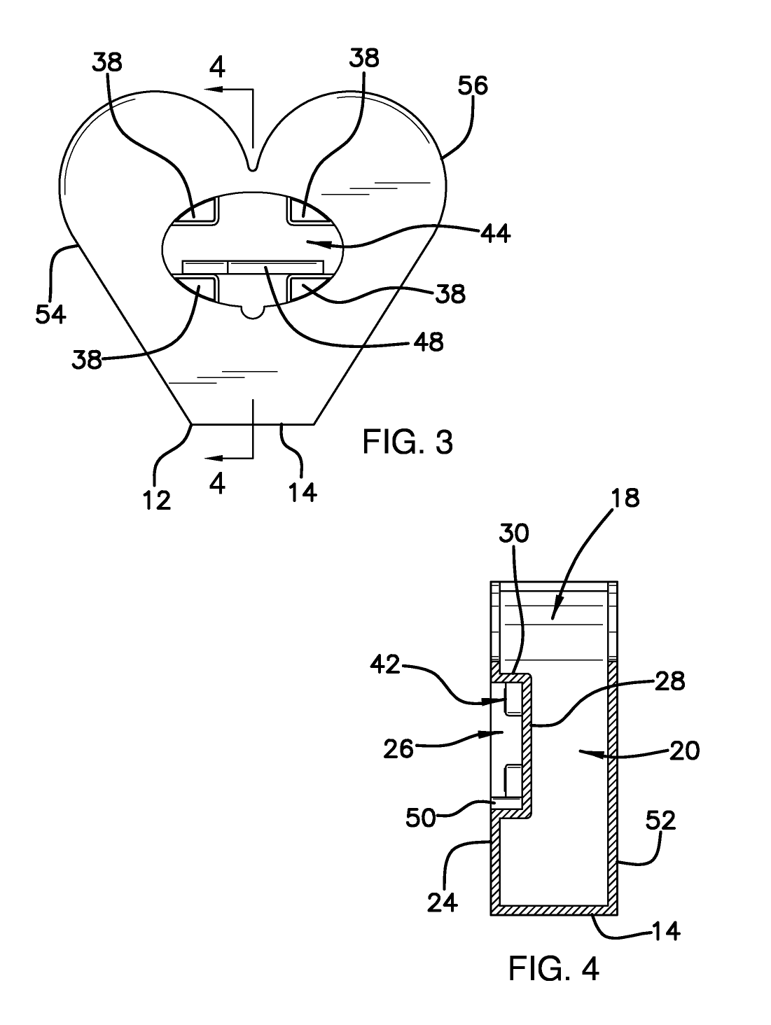

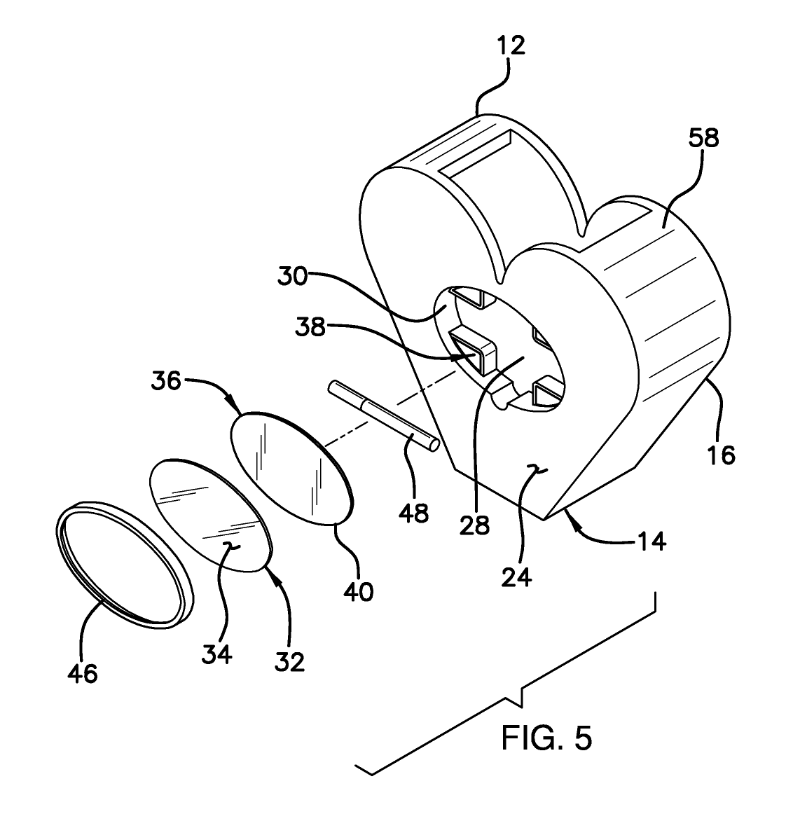

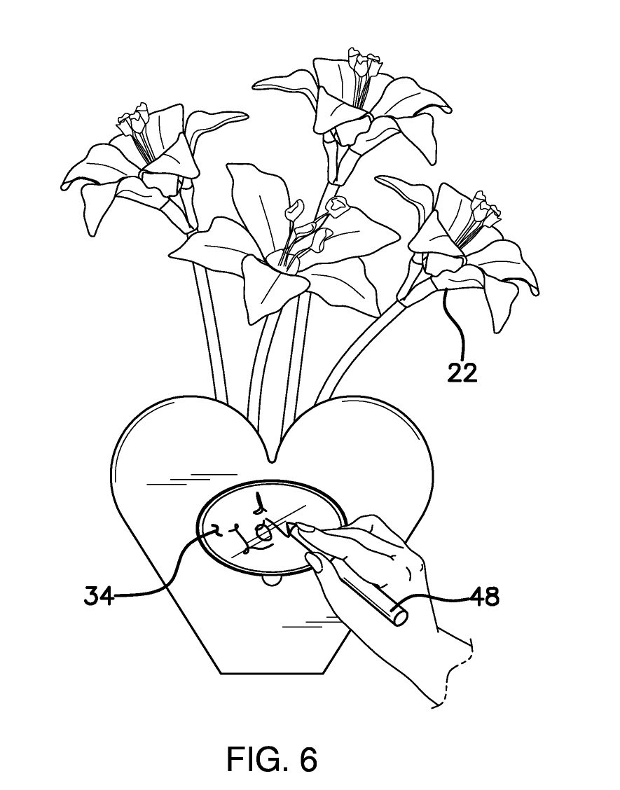

With reference now to the drawings, and in particular to FIGS. 1 through 6 thereof, a new container and writing surface combination device embodying the principles and concepts of an embodiment of the disclosure and generally designated by the reference numeral 10 will be described.

As best illustrated in FIGS. 1 through 6, the floral arrangement holder and writing surface combination assembly 10 generally comprises a housing 12 that has a bottom wall 14 and a perimeter wall 16 which is attached to and extends upwardly from the bottom wall 14. The perimeter wall 16 has an upper edge defining an opening 18 into an interior 20 of the housing 12. The opening 18 may be configured to receive a plurality of flowers 22 such that the flowers 22 extend upwardly above the housing. The housing 12 will generally be fluid impermeable, particularly at a juncture of the bottom wall 14 and the perimeter wall 16 to allow fluid to be held within the housing 12 for the purpose retaining the flowers 22 in a hydrated state. It should be understood that other objects including dried flowers, candy, stick mounted fruit, pastries and stick mounted pastries and other gifts of the like that may be placed in a floral-type arrangement may be positioned in the housing instead of or in combination with flowers 22. The housing 12 may have any conventional size which is associated with vases though typically the height will be less than about 30.0 inches or 76.2 cm.

The perimeter wall 16 includes a front wall 24 and the front wall 24 has a depression 26 therein. The depression 26 is defined by a rear wall 28 and a peripheral wall 30 wherein the peripheral wall 30 is attached to and extends between the rear wall 28 and the perimeter wall 16. The depression 26 will have an interior dimension typically being less than 2.0 inches (5.08 cm) deep and will have a greatest length or height less than 12.0 inches (30.48 cm). The depression 26 may be fluidly sealed from the interior 20 of the housing 12 to prevent water from flowing from the interior into the depression 26.

A panel 32 is removably positioned in the depression 26. Generally, the panel 32 may have a shape and size substantially similar to an aperture formed in the front wall 24 by the depression 26. Thus, the panel 32 will cover the aperture so that the front wall 24 has the appearance of being substantially solid. The panel 32 has an outer surface 34, which faces outside of the depression 26 and which further comprises a dry erase board. The term “dry erase board” is being used to define any type of material particularly well suited for being marked upon by non-permanent markers, or those markers colloquially known as dry erase markers, such that marks upon the panel 32 are easily wiped away for re-use. Therefore the outer surface 34 of the panel 32 may be a material or coating which resists being permanently marked by a marker or other writing utensil. This will allow the panel 32 to be re-used as needed or to be re-marked should an error occur during the marking process. The panel 32, by being removable, is more easily cleaned, can be carried amongst various persons for signing without moving the entire housing 12, and can be retained, apart from the housing 12, as a keepsake or memento.

A coupler 36 releasably mounts the panel 32 in the depression 26 or mounts the panel 32 to the housing 12 such that the panel 32 covers the depression 26. In either case, the panel 32 will cover the depression 26 such that it is completely or substantially covered. The coupler 36 may include a first mating member 38 positioned within the depression 26 and a second mating member 40 attached to the panel 32 opposite of the outer surface 34. More particularly, the first mating member 38 may be positioned such that the outer surface 34 of the panel 32 is substantially co-planar with an outer surface of the front wall 24 when the first 38 and second 40 mating members are engaged with each other. The first mating member 38 may have a distal surface 42, with respect to the rear wall 28, which is positioned within the depression 26. A space between a plane of the distal surface 42 and the rear wall 28 defines a storage space 44 for reasons which will be described below. The coupler 36 may, more specifically, comprise a magnetic coupler having the first 38 and second 40 mating members being magnetically attracted to each other. For this reason, both the first 38 and second 40 mating members may comprise a magnet or one of the first 38 and second 40 mating members may comprise a magnet while the other one of the first 38 and second 40 mating members comprises a magnetically active metallic plate. It may be beneficial for the second mating member 40 to comprise a magnet to allow the panel 32 to be mounted to alternate, magnetically attractive objects such as, for instance, metallic file cabinets. It should be understood that alternate couplers 36 may be utilized including mechanical first 38 and second 40 mating members or wherein the panel 32 is friction fit into the depression 26 such that the edge of the panel, or a border 46 positioned thereon, acts as the coupler 36 to frictionally engage the peripheral wall 30. The border 46 may comprise a frame holding the panel 32 to the second mating member 40.

A marking utensil 48 comprising a dry erase marker, or its equivalent, is removably positioned within the storage space 44. The dry erase marker 48 will typically comprise a non-permanent ink marker which utilizes an ink that may be selectively removed from the panel 32. The storage space 44 allows a user of the assembly 10 to quickly access a means for marking on the panel 32 and therefore also allows the assembly 10 to be utilized more readily as a kit. Furthermore, the recipient of the assembly 10 will already have at hand a means for altering the panel 32 for re-use.

To facilitate removal of the panel 32 from the housing 12, the front wall 24 may include a notch 50 therein positioned at a juncture of the front wall 24 and the peripheral wall 30. The notch 50 defines a finger space for receiving a person's finger and allows them the ability to grip an edge of the panel 32 to facilitate removal of the panel 32 from the depression 26. Though only one notch 50 is shown in the Figures, it should be understood that two or more notches 50 could be employed.

An example of the housing 12 is shown in the Figures wherein the perimeter wall 16 includes the front wall 24, a back wall 52, a pair of lateral walls 54, 56 and a top wall 58. The top wall 58 includes the opening 18 therein while the front 24 and back 52 walls each is generally heart-shaped. Other shapes for the housing 12 are contemplated.

In one embodiment, having generally the same construction as stated above, the panel 32 may be provided with an outer surface 34 that is permanently marked by a marking utensil 48. In such an embodiment, the benefits of easy removal of the panel 32 for signing as well as the storage afforded the marking utensil 48 are preserved. Such an embodiment may utilize a marking utensil 48 comprising chalk, paint, ink, graphite and their equivalents. The panel 32 may comprise an outer surface of various materials as well including paper, plastic, metal or materials such as slate or paints upon which chalk is easily marked. If chalk and chalk receptive materials are utilized, it should be understood again that chalk marking may be easily erasable and the panel 32 used again.

In use, the housing 12 may be used as a conventional vase or other delivery container having an open top end which allows the contents thereof to extend upwardly over the container. The housing 12 and its contents may then be given as a gift for any special occasion as would flowers, candy and the like in general. The panel 32 allows the giver(s) of the gift to mark upon the housing 12, or vase, to eschew the usage of a card and which may furthermore allow for the re-use of the assembly 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A combination vase and writing surface assembly comprising:
a housing having a bottom wall and a perimeter wall being attached to and extending upwardly from said bottom wall, said perimeter wall having an upper edge defining an opening into an interior of said housing;
said perimeter wall including a front wall, said front wall having a depression therein, said depression being defined by a rear wall and a peripheral wall being attached to and extending between said rear wall and said perimeter wall;
a panel being removably positioned in said depression, said panel having an outer surface, said outer surface comprising a dry erase board;
a coupler releasably mounting said panel in said depression; and
a marking utensil comprising a dry erase marker being removably positioned within said depression.

2. The combination vase and writing surface assembly according to claim 1, wherein said coupler includes a first mating member positioned within said depression and a second mating member attached to said panel opposite of said outer surface.

3. The combination vase and writing surface assembly according to claim 2, wherein said first mating member has a distal surface with respect to said rear wall, a space between a plane of said distal surface and said rear wall defining a storage space, said dry erase marker being positioned within said storage space.

4. The combination vase and writing surface assembly according to claim 3, wherein said outer surface of is panel being substantially co-planar with an outer surface of said front wall when said first and second mating members are engaged with each other.

5. The combination vase and writing surface assembly according to claim 1, wherein said coupler comprises a magnetic coupler.

6. The combination vase and writing surface assembly according to claim 1, wherein said front wall has a notch therein positioned at a juncture of said front wall and said peripheral wall, said notch defining a finger space for facilitating removal of said panel from said depression.

7. The combination vase and writing surface assembly according to claim 1, wherein said perimeter wall includes said front wall, a back wall, a pair of lateral walls and a top wall, said top wall having said opening therein, said front and back walls each being generally heart-shaped.

8. The combination vase and writing surface assembly according to claim 4, wherein said coupler comprises a magnetic coupler.

9. The combination vase and writing surface assembly according to claim 8, wherein said front wall has a notch therein positioned at a juncture of said front wall and said peripheral wall, said notch defining a finger space for facilitating removal of said panel from said depression.

10. The combination vase and writing surface assembly according to claim 4, wherein said front wall has a notch therein positioned at a juncture of said front wall and said peripheral wall, said notch defining a finger space for facilitating removal of said panel from said depression.

11. The combination vase and writing surface assembly according to claim 1, wherein said outer surface of said panel is substantially co-planar with an outer surface of said front wall when said panel is positioned in said depression.

12. The combination vase and writing surface assembly according to claim 11, wherein said front wall has a notch therein positioned at a juncture of said front wall and said peripheral wall, said notch defining a finger space for facilitating removal of said panel from said depression.

13. A combination vase and writing surface assembly comprising:
a housing having a bottom wall and a perimeter wall being attached to and extending upwardly from said bottom wall, said perimeter wall having an upper edge defining an opening into an interior of said housing;
said perimeter wall including a front wall, said front wall having a depression therein, said depression being defined by a rear wall and a peripheral wall being attached to and extending between said rear wall and said perimeter wall;
a panel being removably positioned over said depression, said panel having an outer surface;
a coupler releasably mounting said panel in said depression; and
a marking utensil configured for marking on said panel being removably positioned within said depression.

14. The combination vase and writing surface assembly according to claim 13, wherein said coupler includes a first mating member positioned within said depression and a second mating member attached to said panel opposite of said outer surface.

15. The combination vase and writing surface assembly according to claim 13, wherein said outer surface of said panel is substantially co-planar with an outer surface of said front wall when said panel is mounted to said housing.

16. The combination vase and writing surface assembly according to claim 13, wherein said coupler comprises a magnetic coupler.

17. The combination vase and writing surface assembly according to claim 15, wherein said front wall has a notch therein positioned at a juncture of said front wall and said peripheral wall, said notch defining a finger space for facilitating removal of said panel from said depression.

18. The combination vase and writing surface assembly according to claim 14, wherein said outer surface of said panel is substantially co-planar with an outer surface of said front wall when said panel is mounted to said housing.

19. The combination vase and writing surface assembly according to claim 18, wherein said coupler comprises a magnetic coupler.

20. The combination vase and writing surface assembly according to claim 19, wherein said front wall has a notch therein positioned at a juncture of said front wall and said peripheral wall, said notch defining a finger space for facilitating removal of said panel from said depression.
